(19) United States
(12) Patent Application Publication
(10) Pub. No.: US 2009/0189406 A1
(43) Pub. Date: Jul. 30, 2009

(54) TAILGATE LIFT ASSISTOR

(75) Inventor: John Gleason, South Lyon, MI (US)

Correspondence Address: GIFFORD, KRASS, SPRINKLE,ANDERSON & CITKOWSKI, P.C, PO BOX 7021, TROY, MI, 48007-7021, US

(73) Assignee: Z F GROUP NORTH AMERICAN OPERATIONS, INC., Northville, MI (US)

(21) Appl. No.: 12/363,124

(22) Filed: Jan. 30, 2009

Related U.S. Application Data
(60) Provisional application No. 61/024,744, filed on Jan. 30, 2008.

(51) Int. Cl. B60P 1/26; B62D 33/03

(52) U.S. Cl. 296/57.1; 49/386

(57) ABSTRACT

A tailgate lift assistor that provides for a reduced force required to rotate or pivot a tailgate of a pickup truck or the like upwardly from a generally horizontal open position to a generally vertical closed position and in one embodiment the lift assistor is combined with a dampening mechanism that dampens the opening of the tailgate.

### CROSS-REFERENCE TO RELATED APPLICATIONS

This Application claims priority of U.S. Provisional Patent Application Ser. No. 61/024,744 filed on Jan. 30, 2008.

### FIELD OF THE INVENTION

The present invention is directed to device for assisting in the movement of the tailgate of a truck or the like from an open to a closed position and more particularly in one embodiment of the invention to such an assistor combined with a dampener for damping movement of the tailgate from an upper to a lower position

### BACKGROUND OF THE INVENTION

Pick-up trucks typically have a tailgate that prevents material, objects, etc. from escaping from the bed of the truck when in the closed position. The tailgate is typically opened using a hand latch that allows the tailgate to swing in a downward position and provide horizontal access to the bed. Once the tailgate is lowered to a generally horizontal position, lifting of the tailgate to its former upright position requires physical exertion. This physical exertion can be difficult for an individual depending upon their physical capability. Therefore, a tailgate lift assistor would be desirable. In addition, most tailgates have a restraining mechanism that prevents the tailgate from lowering below the horizontal position. However, these mechanisms typically do not prevent the tailgate from opening in a free fall fashion and coming to an abrupt stop when the restraining mechanism has permitted the tailgate to reach a permitted lower position. The opening of the tailgate in such a free fall fashion can damage and wear relevant parts associated with the tailgate as well as the restraining mechanism itself. Therefore, including a tailgate opening dampening mechanism in combination with a lift assistor would also be desirable.

### SUMMARY OF THE INVENTION

The present invention includes a tailgate lift assistor that provides for a reduced force required to rotate or pivot a tailgate from a generally horizontal position up to a generally vertical position. As such, the present invention has utility as a tailgate component. In addition, the tailgate lift assistor can be combined with a dampening mechanism that dampens the opening of a tailgate on a pick-up truck.

The tailgate lift assistor includes a torsion rod that is placed under torsional stress during the lowering of the tailgate from an upright position to a down position. The torsion rod is provided with a tab, lever, catch, and the like that exerts a generally upward force on the tailgate when the tailgate is in the down position. The generally upward force on the tailgate thereby reduces the force required to pivot, or sometimes referred as to “lift”, the tailgate from the generally horizontal position to the generally upright position. If included, the dampening mechanism includes a housing with a tailgate shaft and a dampening device that applies resistance to the rotation of the tailgate shaft. The tailgate shaft can be fixedly attached to the tailgate with resistance on the shaft providing a smooth and controlled opening and closing of the tailgate. In some instances, the torsion rod can be attached in series with the dampening mechanism.

### BRIEF DESCRIPTION OF THE DRAWINGS

A better understanding of the present invention can be had upon reference to the following drawings in which;

FIG. 1 is a fragmentary perspective view of a pickup truck illustrating a tailgate suitable for use with the present invention;

FIG. 2 is a fragmentary perspective view partially in section of an embodiment of the present invention;

FIG. 2A is a fragmentary cross sectional view of the torsion rod of the tailgate assistor of the present invention;

FIG. 3 is a diagrammatic view of a portion of the structure of the tailgate assistor of the present invention illustrating the tail gate in an upper, closed position;

FIG. 4 diagrammatic view similar to FIG. 3 but illustrating the position of the tailgate assistor when tail gate is moved to a position between a closed position and an open position;

FIG. 5 is a diagrammatic view similar to FIG. 3 but illustrating the position of the tail gate assistor when tail gate in a lower open position;

FIG. 6 is a view similar to FIG. 2 but illustrating another preferred embodiment of the present invention;

FIG. 7 is an exploded perspective view of the tailgate dampening mechanism of the present invention;

FIG. 8 is an end elevational view of the housing shown in FIG. 7;

FIG. 9 is a at op elevational view of the shaft insert shown in FIG. 7;

FIG. 10 is diagrammatic view illustrating the damping effect provided by the dampener mechanism;

FIG. 11 is a cross-sectional view of another dampener of the present invention; and

FIG. 12 is a cross-sectional view taken substantially along line 12-12 of FIG. 11.

### DETAILED DESCRIPTION OF THE PREFERRED EMBODIMENTS

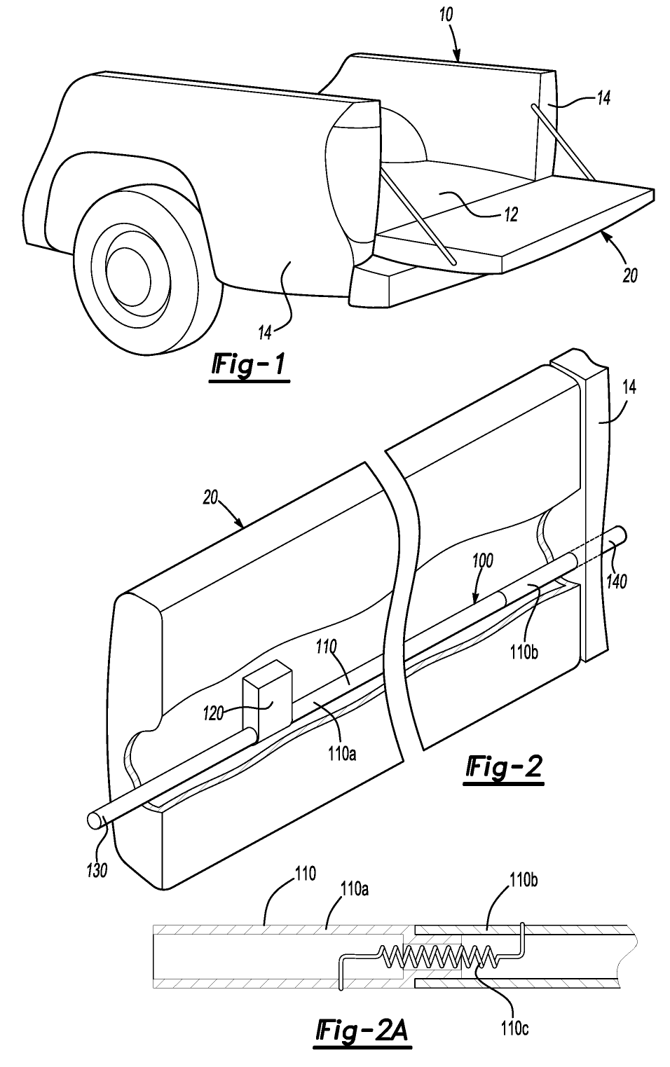

Referring now to FIG. 1, a bed 10 and a tailgate 20 of a pick-up truck are shown. The tailgate 20 can be pivotally attached by conventional means to the pick-up truck proximate the bed floor 12 of the bed 10. The tailgate 20 is shown in the lower open position in FIG. 1.

Turning now to FIG. 2, a larger view of the tailgate 20 is shown wherein an embodiment of the present invention is illustrated. The embodiment includes a torsion spring 100 that is located at least partially within the tailgate 20. In some instances, the torsion spring 100 can be in the form of a torsion rod 110 extending through the tailgate 20. The rod 110 includes a first end 130 and a second end 140. The first end 130 can be inserted within an aperture (not shown) of one of the sidewalls 14 of the bed 20 and be operable to rotate within said aperture. In contrast, the second end 140 is a fixedly attached to another sidewall 14 of the bed 20 and thus, does not rotate. Attached to the torsion rod 110 is a tab or lever 120.

As can best be seen in FIG. 2A the torsion rod 110 is of conventional construction with mating tubes 110a and 110b mounted to axially separately rotate and joined by an internal spring 110c which resists relative axial movement between the tubes 110a and 110b. The end 140 of tube 110b is fixed to the sidewall 14 and the end 130 of the tube 110a is free to axially rotate with respect to the sidewall 14 resisted only by the spring 110c. The tab 120 is attached to the tube 110a of torsion rod 110.

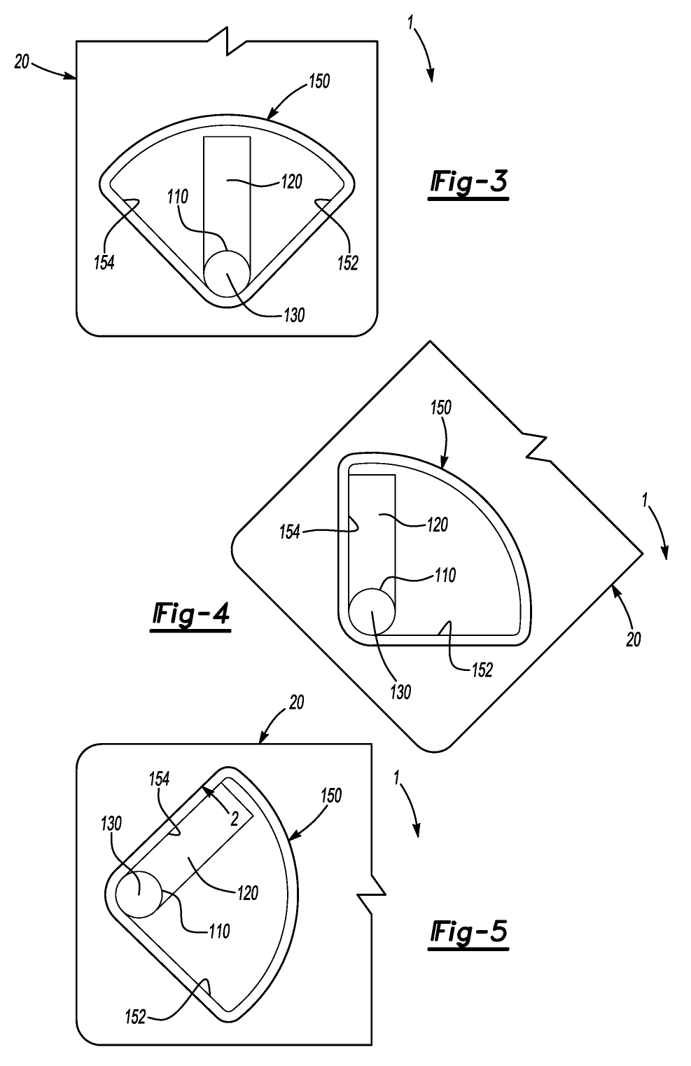

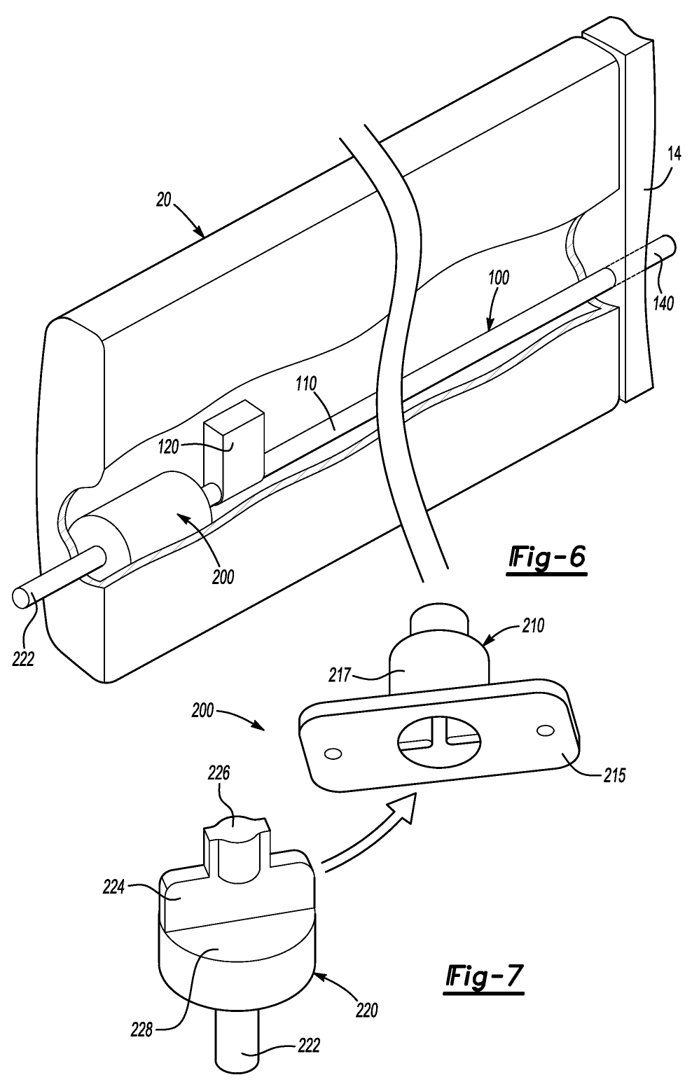

Turning now to FIGS. 3-5, a housing 150 not shown in FIG. 2 can be present as part of and/or within the tailgate 20 with the tab 120 of the torsion spring 100 located at least partially within the housing 150. The housing 150 can have a first side 152 and a second side 154. The housing 150 is fixedly attached to the tailgate 20 such that when the tailgate 20 pivots in the first direction 1, (FIG. 4) so does the housing 150. Thus, as illustrated in FIG. 4, with the tailgate 20 moving in the first direction l,from the upper closed position of the tailgate 20 shown in FIG. 3 the second side 154 of the housing 150 will eventually come into contact with the tab 120. Upon further rotation of the tailgate 20 in first direction 1, for example when the tailgate 20 is lowered to a lower open position as illustrated in FIG. 5, the second side 154 applies force to the tab 120, thereby causing the tab 120 and the tube 110a of the torsion rod 110 to rotate in the first direction 1, as shown in FIG. 5. Rotation of the torsion rod 110 against the bias of the spring 110c (FIG. 2a) creates an opposite force upon the second surface 154 in the second direction 2. It is appreciated that the force applied by the tab 120 upon the second surface 154 is such that the tailgate 20 can be lowered to the down position and will remain there until lifted by an individual. It is also appreciated that upon lifting of the tailgate 20 by an individual, the force of the tab 120 on the second surface 154 will result in a reduced force required by an individual to move the tailgate from the generally horizontal position. It is still yet appreciated that the resistance applied to the second surface 154 by the tab 120 when the tailgate 20 is being moved from an upright position to a down position can provide a dampening effect to the lowering of the tailgate. Although illustrated as a spring biased torsion rod 110 the necessary rotational bias could also be in the form of a wound spring, a hydraulic cylinder, and the like.

In some instances, the torsion rod 110 can be connected in series with a tailgate shaft dampening mechanism 200 as illustrated in FIG. 6. As best seen in FIG. 7 the dampening mechanism 200 preferably includes a housing 210 and a shaft insert 220. The housing 210 can have a mount plate 215 and a cavity region 217. The shaft insert 220 includes a tailgate shaft 222, a paddle surface 224, a housing shaft 226 and a flat surface 228. The shaft insert 220 can be inserted within the cavity region 217 of the housing 210 such that the tailgate shaft 222 extends therefrom. The tailgate shaft 222 is freely rotatably mounted in the sidewall 14 opposite the end 140 of the torsion rod 110.

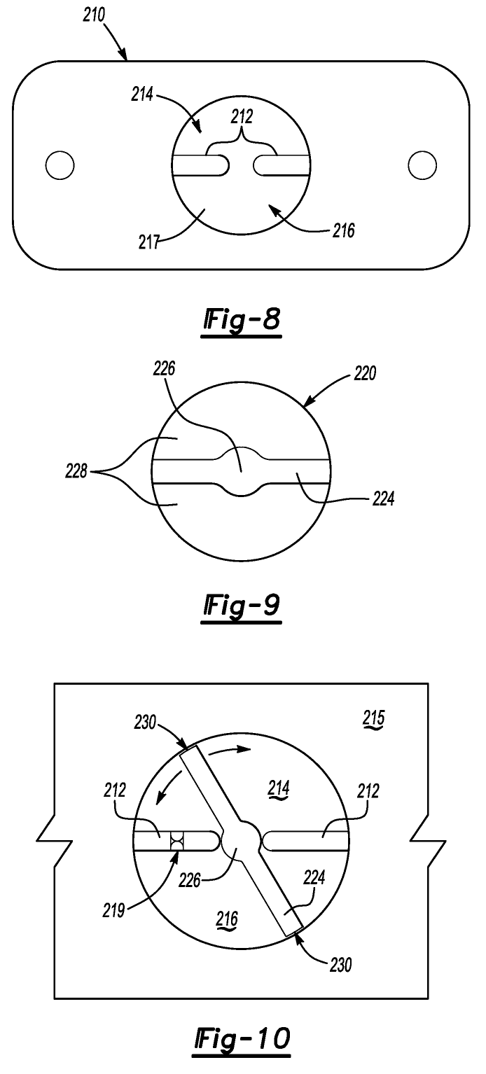

Within the cavity region 217 of the housing 210 are divider plates 212 (FIG. 8) providing a first chamber 214 and a second chamber 216. As can best be seen in FIG. 7 the tailgate shaft 222 extends from a bottom region of the shaft insert 220 and the housing shaft 226 extends from a top region. The top region includes the paddle surface 224 and two flat surfaces 228 (FIG. 9) adjoining the bottom region and the top region.

Referring now to FIG. 10, the dampening mechanism 200 is shown in an assembled condition. with the shaft insert mounted within the housing 210. As shown in the drawing, the paddle surface 224 and the housing shaft 226 fit between the two dividers 212. A clearance 230 is provided between the inside surface of the cavity region 217 and the paddle surface 224. In addition, one of the dividers 212 includes a one-way valve 219.

Upon insertion of the shaft insert 220 within the housing 210, a viscous fluid is provided within the cavity region 217. The viscous fluid (not shown) prevents an unrestrained rotation of the shaft insert 220. In addition, the clearance 230 between the paddle surface 224 and the inner surface of the cavity region 217 affords for a desired restrained rotation of the shaft insert 220.

In operation, the tailgate shaft 222 is fixedly attached to the first end 130 of the torsion rod 110. Upon lowering of the tailgate 20 from the closed position to the open position, the shaft insert 220 rotates in a clockwise or counter-clockwise position depending upon the location of the dampening mechanism 200. Upon rotation of the shaft insert 220, the viscous fluid within the first chamber 214 and second chamber 216 resists the movement of the paddle surface 224. However, the clearance 230 between the paddle surface 224 and the inner surface of the cavity region 217 affords a restrained rotation of the shaft insert 220 and therefore a restrained lowering of the tailgate 20 from the closed position to the open position. Upon closing the tailgate from the open position to the closed position, the one-way valve 219 affords for the flow of the viscous fluid between the first chamber 214 and the second chamber 216. By allowing the flow of the viscous fluid between the two chambers, the extent or magnitude of the restraint on rotation of the shaft insert 220 experienced during the raising of the tailgate 20 is not experienced. In addition, the torsion spring 100 provides a decrease in the force required to lift the tailgate from the generally horizontal position. In this manner, the tailgate 20 can be closed in a timely manner without excessive force. It is appreciated that the housing 210 with the shaft insert 220 inserted therein is mounted on the sidewall of the bed 210 in such a location to afford for the proper mounting of the tailgate 20 onto the pick-up truck.

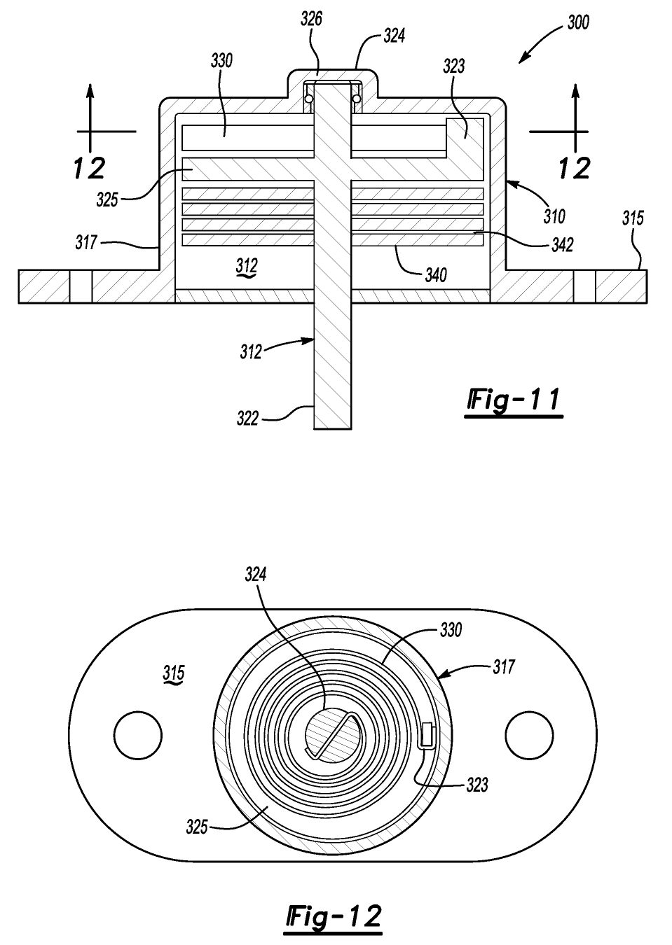

Turning now to FIGS. 11 and 12, another embodiment of a shaft dampening mechanism is illustrated at reference numeral 300. The shaft dampening mechanism 300 can include a housing 310 and a shaft 320. The housing 310 can include a mounting plate 315 and a cavity region 317. The shaft 320 has a tailgate end 322 and a housing end 324. The tailgate end 322 can be fixedly attached to the first end 130 of the torsion spring 100. It is appreciated that the tailgate end 322 of the shaft 320 and the first end 130 of the torsion spring 100 can be attached with a clutch mechanism that provides a desired slippage therebetween.

The housing end 324 is dimensioned such that it can be received by the cavity region 317. An optional bearing 326 can be included to afford for improved rotation of the shaft 320. The shaft 320 also includes a shaft plane 325 that extends in a radial direction from the shaft 320. Extending from the shaft plate 325 is a torsion spring lever 323. The torsion spring 330 is provided and can be attached to the shaft 320 and the torsion spring lever 323 as illustrated in FIG. 12. When attached to the shaft 320 and lever 323, the torsion spring 330 affords restraint on the rotation of the shaft 320. As observed in FIG. 12, the torsion spring 330 would afford restraint on the counter-clockwise rotation of the shaft 320.

Optionally included is at least one shear plate 340 which can be located adjacent to the shaft plate 325. A clearance 342 is provided between the shear plate 340 and the shaft plate 325. In addition, a plurality of shear plates 325 can be provided with the clearance 342 included therebetween. Within the cavity region 317 a fluid reservoir 312 can be provided wherein a viscous fluid can be contained. In addition, a seal 350 can be included such that the viscous fluid does not leak from the reservoir region 312. Upon rotation of the shaft 320 with the shear plate 340 attached thereto the viscous fluid can restrain the rotation.

In operation, the restraint on the rotation of the shaft 320 and thus the tailgate 20 can be afforded by a combination of the torsion spring 330 and the shear plate 340 with viscous fluid between shaft plate 325 and shear plate 340. In this manner, dampening of the lowering of the tailgate 20 is provided. In additional, attachment of the torsion spring 100 to the shaft dampening mechanism 200 and/or 300 affords for a generally upward force to be applied to the tailgate when said tailgate is in the generally lowered horizontal position. Therefore, less force is required by an individual to raise the tailgate 20 from the horizontal position and into the upright position. It is appreciated that the length, diameter, shape, material, and the like of the torsion spring 100 can be adjusted and/or altered such that a desired upward force on the tailgate 20 is applied.

It is also appreciated that the present invention includes any type of shaft rotation dampening mechanism and/or tailgate lift assistor wherein a shaft fixedly attached to a tailgate experiences a desired restrained rotation and/or desired upward force as the tailgate is moved from the closed position to the open position and then from the open position to the closed position, respectively. The various components of the tailgate lift assistor and/or the shaft dampening mechanism can be made from any material known to those skilled in the art, illustratively including metals, alloys, plastics, ceramics, and combinations thereof. The viscous fluid can include any fluid having suitable viscosity, illustratively including water, oil and other organic and/or non-organic fluids.

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

I claim:

1. A tailgate lift assistor comprising:
a torsion spring having a fixed end fixedly attached to a first sidewall of a tailgate bed and a second end rotatably attached to a second sidewall of the tailgate bed, said torsion spring having a tab extending in a generally perpendicular direction from said torsion spring;
a housing fixedly attached to the tailgate and operable to engage said tab of said torsion spring when the tailgate moves from an upright position to a down position and apply a first force to said torsion spring;
said torsion spring operable to apply a second force to said housing, for the purpose of reducing a third force required by an individual to lift a tailgate from a down position to an upright position.

2. The tailgate lift assistor of claim 1, wherein said torsion spring is a torsion rod,
said torsion rod having a first end fixedly attached to said first sidewall of said tailgate bed and a second end rotatably attached to said second sidewall of said tailgate bed;
said torsion rod comprising a first tube and a second tube axially rotatably mounted together;
biasing means connecting said tubes to resist rotatable movement of said first tube with respect to said second tube.

3. The tailgate lift assistor of claim 2 and in which said tab is affixed to said first tube to rotate therewith whereby rotational movement of said tab is resisted by said biasing means.

4. A tailgate lift assistor comprising:
a lift mechanism including a spring urging the tailgate from a lower open position toward an upper closed position.

5. The invention as defined in claim 4 and including a dampener for damping movement of said tailgate.

6. The invention as defined in claim 5 and in which said dampener dampens movement in either direction between an upper closed position and a lower closed position.

7. The invention as defined in claim 6 and said dampener including means to regulate the damping force.
